(19) United States
(12) Patent Application Publication
(10) Pub. No.: US 2009/0019745 A1
(43) Pub. Date: Jan. 22, 2009

(54) Self-care awareness articles, method of making, and method of using

(76) Inventor: Valerie Mosley, Weston, MA (US)

Correspondence Address: Valerie Mosley, 130 Summer Street, Weston, MA, 02493, US

(21) Appl. No.: 11/880,332

(22) Filed: Jul. 19, 2007

(51) Int. Cl. G09F 21/02; G09F 1/08

(52) U.S. Cl. 40/586; 40/538

(57) ABSTRACT

The present invention is directed to articles marked with a design resembling an oxygen mask and articles which themselves resemble an oxygen mask. Such articles are useful in promoting self-care awareness and improving self-care. Particularly preferred articles include, for example, headwear, footwear, eyeglasses, sunglasses, articles of clothing, hair accessories, writing utensils, stationery, paperweights, keychains, jewelry, magnets, drinking glasses, dishes, napkins, napkin holders, sheets, towels, and picture frames.

### FIELD OF THE INVENTION

The present invention relates generally to self-care awareness articles, and more particularly to articles formed in the shape of an oxygen mask and articles marked with an oxygen mask-shaped design.

### BACKGROUND OF THE INVENTION

The concept of taking care of oneself first so that one can better care for others is known. For example, many airlines, as part of routine take-off procedures, instruct passengers to put on their own oxygen mask before assisting others in case of an emergency. This instruction is given so that passengers are aware that they may not be able to help others who need their assistance if they forget to take care of themselves first.

This philosophy is also critical in everyday life, yet many people disregard it or need to be reminded frequently of its importance. Many individuals spend a significant amount of time taking care of and doing things for others, and quite often these same caring individuals forget to place themselves as a priority on the list of persons needing attention.

For example, some men see themselves as the provider for the family and often feel overwhelmed with responsibility. They work hard to give and provide, yet many of them forget to provide for themselves also. The idea of taking care of yourself first is also challenging for women, especially because many women are taught that their value lies in how well they care for others. Many of these women spend so much of their time doing things for others that they forget to care of themselves. Over time, such men and women tend to be less capable of taking care of others than if they had first taken good care of themselves.

Thus, there remains a need for articles that can serve as reminders for individuals to take care of and invest in themselves as a top priority, which will enable them to better care for others. The present invention provides such articles and the use thereof to promote self-care awareness and improve self-care.

### SUMMARY OF THE INVENTION

In one embodiment, the present invention is directed to a method of promoting self-care awareness. The method comprises displaying an article resembling an oxygen mask, wherein the article is non-functional for medical purposes.

In another embodiment, the present invention is directed to a method of making a self-care awareness article. The method comprises marking an article with a design resembling an oxygen mask to produce the self-care awareness article.

In yet another embodiment, the present invention is directed to a self-care awareness article produced by a method disclosed herein.

### DETAILED DESCRIPTION OF THE INVENTION

For purposes of the present invention, the term “self-care” generally refers to taking care of oneself. Because individuals have different needs, “self-care” for one individual may be different than that for another individual, or it may be different for the same individual at different points in time. On a basic level, self-care typically refers to getting adequate rest, eating and drinking healthily, exercising, etc. On a more advanced level, self-care refers to focusing on energizing oneself and doing those things that bring one joy, for example, by rejuvenating one's mind, spirit, and body. Broadly speaking, it refers to doing things that allow an individual to be all that they can be, e.g., to embrace, love, and respect who they are, eliminate paralyzing fear, empower themselves to live passionate, pleasant, and profitable lives, etc., so that they can make a difference to others. Thus, self-care involves activities that make individuals feel good about themselves including, but not limited to, eating healthily, resting, exercising, learning about health and finances, getting regular medical check-ups, journal writing, etc. “Self-care” in the context of the present invention is akin to watering one's “inner plant” such that it is not wilted and will allow the best of one's natural beauty to shine.

By the present invention, it has been found that self-care can be promoted using articles which are marked with a design resembling an oxygen mask and articles which themselves resemble an oxygen mask. Displaying such articles preferably promotes self-care awareness, for example, by serving as a reminder for individuals to take care of themselves properly so that they may better help others.

Articles of the present invention which are marked with a design resembling an oxygen mask include, but are not limited to, headwear and footwear; eyeglasses and sunglasses; articles of clothing; hair accessories; writing utensils; stationery; trinkets and collectibles, such as paperweights, keychains, magnets, jewelry, and charms; and domestic products, such as drinking glasses, dishes, napkins and napkin holders, sheets, towels, and picture frames. The oxygen mask design is placed on any visible portion of the article, and an article may contain one, two, or multiple oxygen mask designs thereon. For articles containing more than one oxygen mask design thereon, the oxygen mask designs may be the same or different in color, shape, or texture.

Articles of the present invention which themselves resemble an oxygen mask include, but are not limited to, articles such as jewelry, paperweights, magnets, trinkets, cups, dishes, and bowls that are formed in the shape of an oxygen mask, and may be fabricated from a number of materials known to those of ordinary skill in the art including, but not limited to, natural or synthetic resin, plastic, fabric, glass, wood, metal, alloy, composite, and any combination thereof.

Oxygen masks are well known by those of ordinary skill in the art, and the present invention is not meant to be limited by any particular oxygen mask design.

In a particular embodiment, the present invention provides a method of making a self-care awareness article. The method comprises marking an article with a design resembling an oxygen mask. The present invention is not limited by any particular method for marking the article with the design. Suitable methods for marking the article include, but are not limited to, painting, printing, iron-on transfer, screen-printing, engraving, etching, and other conventional design creation and transfer methods.

In another particular embodiment, the present invention provides a method for promoting self-care awareness. The method comprises displaying an article resembling an oxygen mask. The present invention is not limited by any particular method for displaying the article. In general, an article is “displayed” if it is being used for its intended purpose. For example, paperweights are generally displayed by placement on a flat surface, such as a desk or dresser; jewelry is generally displayed when it is worn; cups, dishes, and bowls are generally displayed by placement in a display case or by using them for consuming or serving food and beverages; etc.

While the illustrative embodiments of the invention have been described with particularity, it will be understood that various other modifications will be apparent to and can be readily made by those of ordinary skill in the art without departing from the spirit and scope of the invention. Accordingly, it is not intended that the scope of the claims appended hereto be limited to the examples and descriptions set forth herein, but rather that the claims be construed as encompassing all of the features of patentable novelty which reside in the present invention, including all features which would be treated as equivalents thereof by those of ordinary skill in the art to which the invention pertains.

What is claimed is:

1. A method of making a self-care awareness article, the method comprising:
marking an article with a design resembling an oxygen mask to produce the self-care awareness article.

2. The method of claim 1, wherein the article is selected from the group consisting of headwear, footwear, eyeglasses, sunglasses, articles of clothing, hair accessories, writing utensils, stationery, paperweights, keychains, jewelry, magnets, drinking glasses, dishes, napkins and napkin holders, sheets, towels, and picture frames.

3. The method of claim 1, wherein the article is marked two or more times with a design resembling an oxygen mask.

4. A self-care awareness article produced by the method of claim 1.

5. A method of promoting self-care awareness, the method comprising:
displaying an article resembling an oxygen mask, wherein the mask is non-functional for medical purposes.

6. The method of claim 5, wherein the article is selected from the group consisting of jewelry, paperweights, magnets, cups, trinkets, dishes, and bowls.
